(19) United States
(12) Patent Application Publication
(10) Pub. No.: US 2017/0327366 A1
(43) Pub. Date: Nov. 16, 2017

(54) Apparatus/Devise that produces cold soda drink by plug it into the water home key tap, amending and mixing unit composition of elements to make high quality drink for human consumption, ie just plug it in to produce an orgasm of cold soda drink

(71) Applicant: CARLOS MORALES URQUIZA, MEXICO CITY (MX)

(72) Inventor: CARLOS MORALES URQUIZA, MEXICO CITY (MX)

(21) Appl. No.: 15/530,886

(22) Filed: Mar. 15, 2017

(51) Int. Cl. B67D 1/00; B67D 1/08

(52) U.S. Cl. CPC B67D 1/004; B67D 1/0888; B67D 1/0021; B67D 1/0877; B67D 1/0884

(57) ABSTRACT

The “Electro-Mechanic device in Cylindrical Standard Soda Can Shape with inlet and outlet to connect to the water home tap, with Several inner compartments containing different materials, stream connected with chemicals that are filtering, changing and mixing the molecular composition of Running Water, Separating and joining elements in order to produce Cold Soda Drinks. Containing an integrated micro computer that regulates the temperature in each compartment and chemical processes, and a screen that transmits Audio and Video Commercials, where you can select the flavor of Soda you want and it confirms when the soda is high quality ready to pop and drink”.

The present invention relates to: “Electro-Mechanic device in Cylindrical Standard Soda Can Shape with inlet and outlet to connect to the water home tap, with Several inner compartments containing different materials, stream connected with chemicals that are filtering, changing and mixing the molecular composition of Running tap Water, Separating and joining elements in order to produce Cold Soda Drinks. This devise contains an integrated micro computer that regulates the temperature in each compartment and chemical processes, and a screen that transmits Audio and Video Commercials, where you can select the flavor of Soda you want and it confirms when the soda is high quality ready to pop and drink”.

It consists of a device in the form of Standard soda that contains an entry with Plug on top to connect to the Home water tap, and contains inside a number of compartments with different materials, connected through a serpentine streaming tube, its compartments are opened and closed, changing its temperature, mixing and producing chemical reactions at molecular level from the tap water that is received and passes through the serpentine streaming tube. The device is connected in its entirety to an integrated micro computer containing an intelligent processor that regulates the opening and closing of the compartments and regulates the flow of liquid and the chemical process to produce a high quality cold soda drinks.

The Devise integrated Micro Computer is connected to a Rechargeable Battery, allowing No electrical outlets, also connected to an integrated display on the outside of the device with a screen Audio and Video covering the cylindrical surface of the Cabinet as a Soda Can, that presents to the user with various advertisements of the soft drinks company and lets the user select the kind of soft drinks he/she wants, and issues a notice when the refreshment is ready to pop and drink.

The microcomputer has a computer program further regulates the chemical process of production of soda according to a specific formula. Also closes the device and alerts, If tap water is of poor quality the device is closed and you are issued an alert, or if you try to open the device it self-destructs, shooting it down, closing and mixing all the elements to prevent the chemical process Formula and intel known, preventing hackers to get any intel.

Its use: any person can connect the device to the home/office tap water outlet or water carboy, so that the device produces cold high quality soda drinks with different flavors.

Explaining that instead of continually buying soda bottles, only buy a device you connect to your home water tap and you get good cold soda, ie shops such as once a month/year.

A touch screen that surrounds the cylinder apparatus presents an Audio Video with ads and views of nature and the soft drink company.

Saving in manufacture of beverages, saving plastic bottles (making greener and friendlier to our environment without use of plastics and aluminum), saving on transportation, saving shelf space Warehouses and stores, cooler space savings, weight savings to be loaded by customers and in plastic bags and cardboard to load bottles. ie a revolution in Beverage industry logistics.

### BACKGROUND

At home generally we buy an average of 5 gallons of soda a week, and my dad always asks me to buy medium size bottles so that they are not too heavy for him to lift when he is serving a drink. But I kept thinking that it is very much the weight of soda bottles a problem, ie physically they weigh too much, and that soft drinks really have a composition of from 70% to 90% water, depending on the formula of each brand or company. Everything you buy in the supermarket, what are the heaviest items? soda bottles.

Understanding that soft drink companies keep very secret formulas to make their drinks, Imagine if we eliminate the weight that represents water and plastic and aluminum, representing savings in logistics and price for soft drinks companies and consumers. Instead of constantly going to the store to buy soda bottles, this device is plugged into the home tap water, and while viewing a soft drinks ad, you get a high quality drinks and even crave to consume more.

I was checking all patents and Patent Cooperation Treaty (PCT) applications and there is nothing remotely similar anywhere in the world so this invention is completely new and has a clear profit for the soft drinks industry and consumers. There is nowhere in the world a similar electromechanical device to perform all activities. The Formula use may vary depending on the soft drinks company requirements. ie it is a new, unique, different and very useful electromechanical device.

The difference is: There are various water filters and there are machines that mix elements of drinks with water, as is the example that we all know of soda machines used in bars, cinemas, restaurants, etc, but There is nowhere in the world a home apparatus or machine that is connected to the tap of running water and the mixture made of various materials at the molecular level, verifying Chemical process, separating and joining elements by movement and temperature increase and decrease, and verifying the composition and purity of the Finished Product, conveying a message of Audio and Video and producing a cold soft drinks for human consumption with a high level of quality with different flavors that the user can select. Some of the advantages are:

1) improving product quality; Generally soft drinks bottles are letting loss of soda once opened, the device only works when the product is cold refreshment with soda and in perfect condition with 100% quality, if not it issues a warning and closes.

2) Improving the Cost: Saving in manufacture of beverages, saving bottles, saving on transportation, saving shelf space Warehouses and stores, space savings at refrigerators, weight savings and customers that do not have to carry plastic bags and heavy bottles.

3) Improving efficiency: Saving energy, Rechargeable Battery no cables or connections; No need to connect to any electrical outlet, the device recharges automatically.

### BRIEF DESCRIPTION OF THE INVENTION

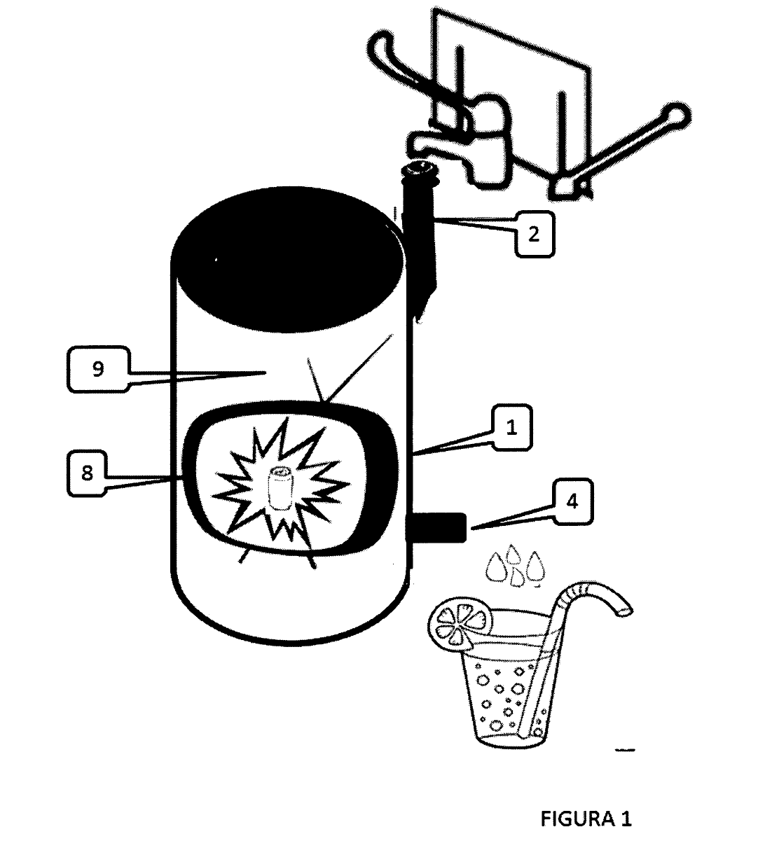

FIG. 1 shows a view outside the: “Electro-Mechanic device in Cylindrical Standard Soda Can Shape with inlet and outlet to connect to the water home tap, with Several inner compartments containing different materials, stream connected with chemicals that are filtering, changing and mixing the molecular composition of Running Tap Water, Separating and joining elements in order to produce Cold Soda Drinks. Containing an integrated micro computer that regulates the temperature in each compartment and chemical processes, and a screen that transmits Audio and Video Commercials, where you can select the flavor of Soda you want and it confirms when the soda is high quality ready to pop and drink”.

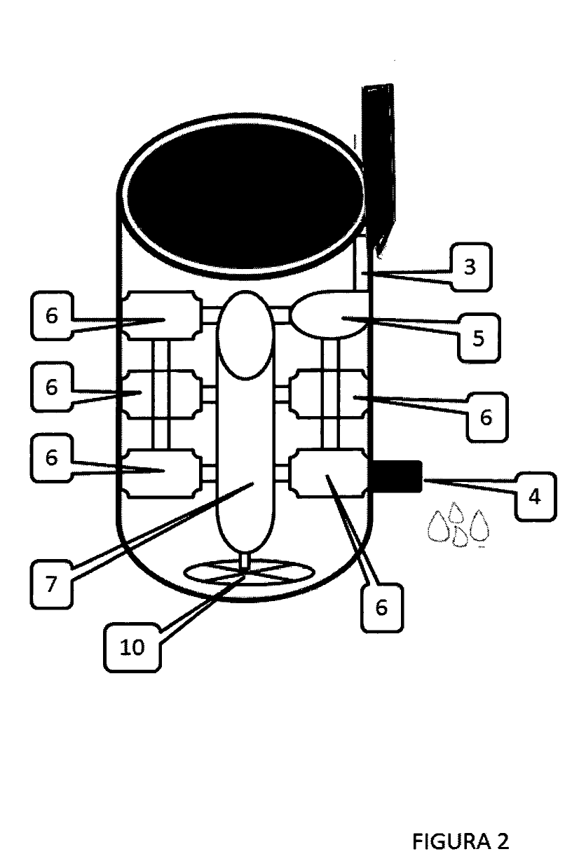

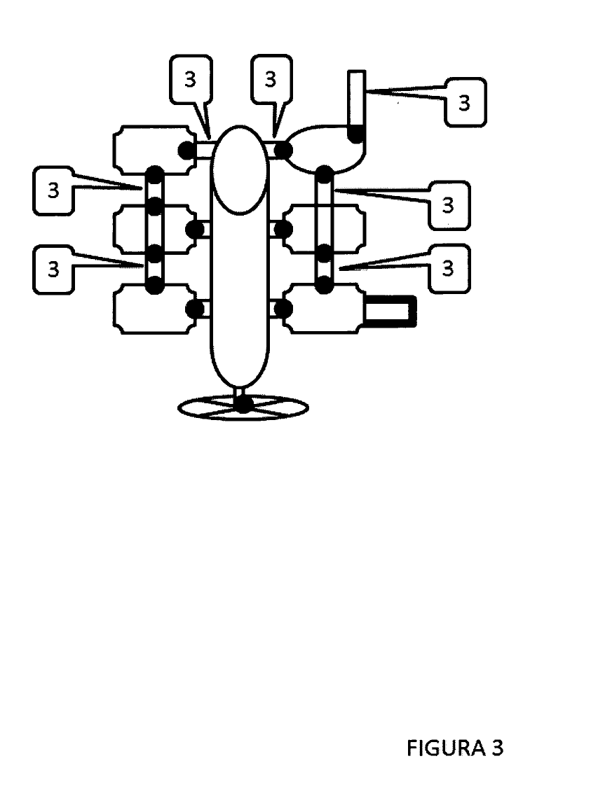

FIG. 2 shows a view from the inside and the elements and parts that comprise it, which are connected via pipes, cables, etc., as shown in FIG. 3.

### DETAILED DESCRIPTION OF THE INVENTION

The “Electro-Mechanic device in Cylindrical Standard Soda Can Shape with inlet and outlet to connect to the water home tap, with Several inner compartments containing different materials, stream connected with chemicals that are filtering, changing and mixing the molecular composition of Running Water, Separating and joining elements in order to produce Cold Soda Drinks. Containing an integrated micro computer that regulates the temperature in each compartment and chemical processes, and a screen that transmits Audio and Video Commercials, where you can select the flavor of Soda you want and it confirms when the soda is high quality ready to pop and drink” consists of a client terminal (1) which performs the function of consolidating all parts of the apparatus, same Terminal Shaped in Cylindrical Standard Refresh soda can containing a standard inlet for water and outlet to pop high quality cold soda drinks (2) inlet that plugs into the water tap or water carboy, which is connected via a tubular Plastic streaming serpentine (3) which performs the function of transporting the liquid from the input socket (2) all the way to the outlet exit (4), same tubular Plastic streaming serpentine that connects to a filter (5) which performs the function of filtering the content Running Water and that is connected via the same coil to several compartments (6) containing different materials, one after the other, each of the compartments perform the function of Filter and mix chemicals at the molecular level, separating and uniting elements, increasing and decreasing the temperature of the same, according to a specific formula, with the function to Modify tap water passing through the coil and to produce a High Quality cold soda drinks for human consumption.

All parts of the apparatus are connected via wires to a small Integrated Micro Computer (7) within the apparatus containing a computer program, Formula and algorithms to perform the function of regulating the process of Opening and Closing compartments (6) that containing various materials, regulates quantities, the chemical process of mixture of components at the molecular level and the temperature of the compartments and the flow of liquid, same microcomputer that is connected via wires to a small touch screen Audio and Video (8) with a Cylindrical shaped form covering all of the apparatus, that performs the function of issuing warnings and messages, and transmits commercials, and where the user can select the type of flavor soda he/she wants, all protected by a hard plastic transparent layer containing a layer of insulating material (9) which keeps the device in a certain temperature.

Likewise, the Micro Computer (7) is connected W a rechargeable battery (10) which performs the function of providing energy to it, without requiring power cables. Chemical Processes are made using a specific formula that governs movement of fluid through all the compartments (6) through the tubular Plastic streaming serpentine (3), and increased and/or decreased temperature and mixing various materials.

The End User must only connect the device to a tap water or jug of water to the appliance run automatically, ie just plug it in to produce an Orgasm of Cold Soda Drinks.

### SUMMARY

“Electro-Mechanic device in Cylindrical Standard Soda Can Shape with inlet and outlet to connect to the water home tap, with Several inner compartments containing different materials, stream connected with chemicals that are filtering, changing and mixing the molecular composition of Running Water, Separating and joining elements in order to produce Cold Soda Drinks. Containing an integrated micro computer that regulates the temperature in each compartment and chemical processes, and a screen that transmits Audio and Video Commercials, where you can select the flavor of Soda you want and it confirms when the soda is high quality ready to pop and drink” that is an interactive devise consistent of a client terminal (1) containing an input plug (2) performing the function to connect to the Key water stream home/office tap or water carboy, that it connects via pipe and cable, to a plastic tube-shaped coil or tubular Plastic streaming serpentine (3) which performs the function of bringing the liquid from the tap water socket (2) and to the Exit key (4) Apparatus/devise, same connects via pipe and cable to a filter (5) Which performs the function of cleaning the water and filtering it, that connects it via pipe and cable, with several compartments (6) performing the function to store various materials, increase and decrease temperature, mixing chemicals and separating and joining elements at the molecular level, connecting them via Pipe and Cable to an integrated microcomputer (7) performing the function of regulating, mixing processes, transformation of elements and components to achieve the goal of producing Cold Refreshment high quality Soda drinks for human consumption, and also connects via cable to a touch screen display of Audio and Video (8) covering the entire circumference of the cylinder apparatus/devise, that performs the function of Issuing Alerts, messages and transmit advertisements, and allowing the user to select different flavors of Cold Soda, same that is coated by an insulating material and protector (9) that performs the function of protecting the apparatus/devise and keep it at certain temperature.
The microcomputer (7) is also connected, via cable, to a rechargeable battery rechargeable battery (10) which performs the function of providing energy to it, without requiring power cables.
The End User must only connect the device to a tap water or jug of water to the appliance run automatically, ie just plug it in to produce an Orgasm of Cold Soda Drinks.
The novelty is that nowhere in the world there is an apparatus/devise that transforms tap Water into a cold, fizzy high quality Soda drink for Human Consumption. The alternative would be to continue bottling soft drinks, transporting, refrigerating, loading and keeping at a very high cost. No doubt that eventually this invention will be used for the army or the space travelers who'll want a cold soda drink.
There is no state of the previous technique (in the world) of any kind of devise, apparatus or equipment for producing soda refreshings which is: autonomous, small and easy to transport, without having to connect to an electric current, differently from dispensing or modifying mixtures, that by nature are of high volume and weight, and whose storage and supply implies much greater space and less efficiency, or algorithms that regulate process or provide publicity or announcements, and see that my patent application has new improvements, efficient and only with the use of the serpentin connected by a microcomputer which solves problems: like the solidification of syrup, avoiding storage of mixtures and its seat and harden.

1. “An Apparatus Devise that produces cold Soda drinks by plug it into the water home key tap, amending and mixing unit composition of elements to make high quality drinks for human consumption” also known as: “Electro-Mechanic device in Cylindrical Standard Soda Can Shape with inlet and outlet to connect to the water home tap, with Several inner compartments containing different materials, stream connected with chemicals that are filtering, changing and mixing the molecular composition of Running Water, Separating and joining elements in order to produce Cold Soda Drinks. Containing an integrated micro computer that regulates the temperature in each compartment and chemical processes, and a screen that transmits Audio and Video Commercials, where you can select the flavor of Soda you want and it confirms when the soda is high quality ready to pop and drink” that is an interactive devise consistent of a client terminal (1) containing an Input plug (2) performing the function to connect to the Key water stream home/office tap or water carboy, that it connects via pipe and cable, to a plastic tube—shaped coil or tubular Plastic streaming serpentine (3) which performs the function of bringing the liquid from the tap water socket (2) and to the Exit key (4) Apparatus/devise, same connects via pipe and cable to a filter (5) Which performs the function of cleaning the water and filtering it, that connects it via pipe and cable, with several compartments (6) performing the function to store various materials, increase and decrease temperature, mixing chemicals and separating and joining elements at the molecular level, connecting them via Pipe and Cable to an integrated microcomputer (7) performing the function of regulating, mixing processes, transformation of elements and components to achieve the goal of producing Cold Refreshment high quality Soda drinks for human consumption, and also connects via cable to a touch screen display of Audio and Video (8) covering the entire circumference of the cylinder apparatus/devise, that performs the function of Issuing Alerts, messages and transmit advertisements, and allowing the user to select different flavors of Cold Soda, same that is coated by an insulating material and protector (9) that performs the function of protecting the apparatus/devise and keep it at certain temperature. The microcomputer (7) is also connected, via cable, to a rechargeable battery rechargeable battery (10) which performs the function of providing energy to it, without requiring power cables.
The End User must only connect the device to a tap water or jug of water to the appliance run automatically, ie just plug it in to produce an Orgasm of Cold Soda Drinks.

2. Cartridges of different sizes in cylindrical plastic form containing all types of honey or flavor and of different colors to be loaded or inserted as hand revolver bullets in the top of Point 1.
of the Claims with the sole purpose and object to fill the (6) Various compartments and connect via interface Male—Female.
